(19) United States
(12) Patent Application Publication
(10) Pub. No.: US 2016/0267527 A1
(43) Pub. Date: Sep. 15, 2016

(54) DYNAMIC RESOURCE ALLOCATION

(71) Applicant: LinkedIn Corporation, Mountain View, CA (US)

(72) Inventors: Donald E. Flood, Oakland, CA (US); Kun Liu, San Jose, CA (US); Tingting Cui, Mountain VIew, CA (US); Karim Filali, Sunnyvale, CA (US); Joshua Carver, San Francisco, CA (US); Vasudha Mithal, San Francisco, CA (US)

(21) Appl. No.: 14/853,120

(22) Filed: Sep. 14, 2015

Related U.S. Application Data
(60) Provisional application No. 62/131,150, filed on Mar. 10, 2015.

(51) Int. Cl. G06Q 30/02

(52) U.S. Cl. CPC G06Q 30/0246

(57) ABSTRACT

A method and system for dynamically re-allocating resources among multiple electronic content delivery channels is provided. The resources may be dedicated for a content targeting campaign that aims to persuade online users to perform a certain action. The content delivery channels provide targeted content to the online users based on the resources that are allocated to the channels. An effectiveness of each content delivery channel is measured. The measures of effectiveness may be used to determine whether and/or how much to a current allocation should be modified. Additionally, one or more rules that govern how to re-allocate resources may be enforced. For example, a rule may be that if a content delivery channel is not utilizing its allocation on a daily basis, then at least a portion of the unused portion is reallocated to another content delivery channel.

### CROSS-REFERENCE TO RELATED APPLICATIONS; BENEFIT CLAIM

This application claims the benefit of U.S. Provisional Application No. 62/131,150, filed Mar. 10, 2015, the entire contents of which is hereby incorporated by reference as if fully set forth herein, under 35 U.S.C. §119(e).

This application is related to U.S. patent application Ser. No. 14/815,873, filed Jul. 31, 2015, the entire contents of which is hereby incorporated by reference for all purposes as if fully set forth herein.

### TECHNICAL FIELD

The present disclosure relates to data processing systems and, more particularly, to dynamically changing an allocation of resources to one or more content delivery channels.

### BACKGROUND

Companies target information to potential customers to show how people may benefit from products or services provided by the companies. Potential customers may be reached through many different content delivery channels, such as through direct email, sponsored content in search result pages, and sponsored content on social media platforms. However, the effectiveness and cost of each channel may vary greatly. One approach for allocating resources to different content delivery channels is to manually specify how many resources will be allocated to each content delivery channel. Once a content delivery channel uses up the resources allocated to that channel, that content delivery channel will not send any more targeted content unless the channel receives additional resources. Such an approach is manual, static, and inefficient.

### BRIEF DESCRIPTION OF THE DRAWINGS

In the drawings:

FIG. 1 is a block diagram that depicts a system for delivering content through different delivery channels, in an embodiment;

FIG. 2 is a flow diagram that depicts a process for dynamically re-allocating resources among multiple content delivery channels, in an embodiment;

FIG. 3 is a flow diagram that depicts a process for allocating resources to multiple content delivery channels, in an embodiment; and

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for dynamically changing allocation of resources across multiple content delivery channels. A campaign initiator aims to present targeted content, referred to herein as “creatives,” to multiple users. Each content delivery channel is responsible for presenting the creatives to one or more users and, in doing so, requires resources provided by the campaign initiator. Thus, one portion of the resources provided by the campaign initiator is allocated to a first content delivery channel and another portion of the resources is allocated to a second content delivery channel.

If one or more criteria are satisfied, then the allocation of resources to one of the content delivery channels is changed automatically, even before the resources of the corresponding campaign have not yet been exhausted. For example, if a first content delivery channel is performing poorly relative to a second content delivery channel, then at least a portion of the resources allocated to the first content delivery channel is re-allocated to the second content delivery channel.

### Content Targeting Campaigns

A “content targeting campaign” is an operation to provide particular content to one or more individuals, typically to persuade the individuals to perform a particular action or set of actions, such as purchase a product or service, make a donation, visit a web site, etc. The particular content may include single message or multiple related messages. The particular content may include an image, text, graphics, audio, video, or any combination thereof.

A content targeting campaign may have a defined start date and/or end date. Alternatively, a content targeting campaign may terminate based on factors that are not known when the campaign begins, such as the sale of a certain number of products, the receipt of a particular number of donations, or the depletion of a funds to finance the campaign.

A content targeting campaign may be initiated by one party or entity and run or managed by another party or entity. For example, a first business entity may contract with a second business entity to run a content targeting campaign on behalf of the first business entity. The first business entity pays the second business entity an amount of money to run the campaign. The amount of money may represent the total amount the first business entity intends to pay for one or more content targeting campaigns. The second business entity determines how to allocate funds to different content delivery channels and how much of the funds to retain for managing the content targeting campaign.

### System Overview

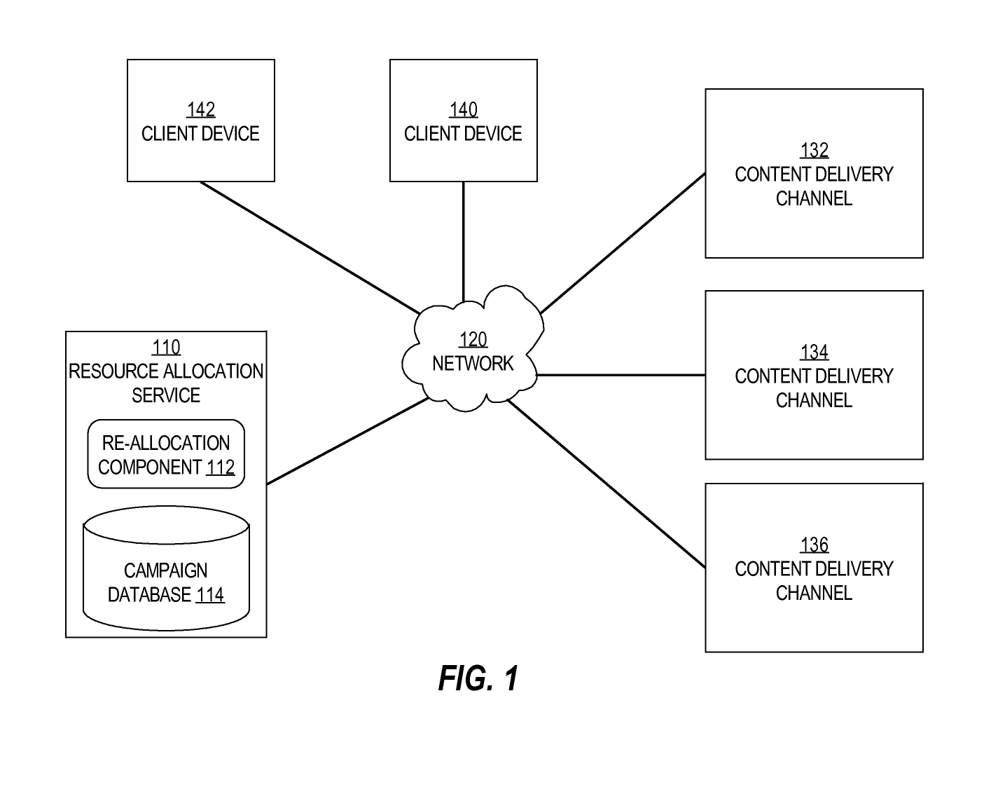

FIG. 1 is a block diagram that depicts a system 100 for delivering content through different content delivery channels, in an embodiment. System 100 comprises a resource allocation service 110, a network 120, content delivery channels 132-136, and client devices 140, 142. While only three content delivery channels 132-136 are depicted, system 100 may include less or more than three. Similarly, while only two client devices 140, 142 are depicted, system 100 may include more than two client devices.

Network 120 may be implemented on any medium or mechanism that provides for the exchange of data between resource allocation service 110 and content delivery channels 132-136. Examples of network 120 include, without limitation, a network such as a Local Area Network (LAN), Wide Area Network (WAN), Ethernet or the Internet, or one or more terrestrial, satellite or wireless links.

### Resource Allocation Service

Resource allocation service 110 includes re-allocation component 112 and campaign database 114. Re-allocation component 112 is configured to determine how to allocate resources among content delivery channels 132-136. Initially, the allocation of the set of resources may be pre-determined or pre-defined. The allocation of a set of resources may be established by resource allocation service 110 (or a representative thereof) or by a campaign initiator if resource allocation service 110 is different than the campaign initiator. Later, certain events or triggers cause the allocation to change before the resources are exhausted, depleted, or otherwise used up.

Resource allocation service 110 is implemented in hardware, software, or a combination of hardware and software. Resource allocation service 110 comprises one or more servers, computers, processors, database servers, and/or computing devices configured to communicate with content delivery channels 132-136 and, optionally, client devices 140, 142 via network 120. Resource allocation service 110 hosts one or more applications, websites, social networks, or other visual or user interface mechanisms related to techniques and data described in detail below. Although resource allocation service 110 is depicted as a single entity in FIG. 1, resource allocation service 110 may, depending on the embodiment, comprise multiple computing devices that may work alone and/or collectively to provide the functionality described herein. Furthermore, resource allocation service 110 may be located at one or more geographically distributed locations.

In an embodiment, resource allocation service 110 is owned or operated by a campaign initiator. For example, resource allocation service 110 may be operated by a company that manufactures high-end products and desires to sell those products to businesses. The company has a limited budget to spend on advertising the products. The company operates resource allocation service 110 to efficiently allocate the budget across multiple content delivery channels.

In an alternative embodiment, resource allocation service 110 is different than a campaign initiator, which provides resources and/or targeted content that will be eventually provided by content delivery channels 132-136 to client devices 140, 142. In this embodiment, the campaign initiator may be one of multiple campaign initiators that interact with resource allocation service 110 in order to intelligently provide resources to content delivery channels 132-136. As an example, a campaign initiator is a marketer that desires to sell a product or service to users who visit one or more of content delivery channels 132-136. The marketer provides a budget and a set of one or more creatives to resource allocation service 110. In turn, resource allocation service 110 sends the creative(s) to each of content delivery channels 132-136 along with allocation data that indicates a portion of the budget that the corresponding content delivery channel may use.

Campaign database 114 comprises volatile memory, non-volatile memory, or both volatile and non-volatile memory. Campaign database 114 includes information about one or more content targeting campaigns. For each content targeting campaign, campaign database 114 may identify or otherwise indicate the corresponding campaign initiator (if different than the party that operates resource allocation service 110), a start date (if any) of the content targeting campaign, an end date (if any) of the campaign, content that will be delivered to multiple content delivery channels, and resource information related to the campaign. For example, the resource information may indicate a certain budget amount, such as $10,000. Resource allocation service 110 determines how the budget will be allocated among content delivery channels 132-136. In this example, resource allocation service 110 may determine to, at least initially, give $100/day to content delivery channel 132 and $200/day to content delivery channel 134.

Campaign information stored in campaign database 114 may also indicate which content delivery channels to use, at least initially, and/or how to initially allocate the resources. Such campaign information may be on a per-campaign basis and/or across multiple campaigns, such as a strict subset of all the campaigns or all the campaigns. For example, for content targeting campaign A, only content delivery channels 132 and 136 are to be used. As another example, for content targeting campaigns involving products valued over $1 million, content delivery channel 136 will not be used. As another example, for all content targeting campaigns indicated in campaign database 114, initially only use content delivery channels 134 and 136.

Campaign information stored in campaign database 114 may also include one or more measures of effectiveness associated with each content delivery channel on a per-campaign basis. A measure of effectiveness (described in more detail below) indicates how effective a content delivery channel metric is. Such campaign information may be on a per-campaign basis and/or across multiple campaigns, such as a strict subset of all the campaigns or all the campaigns. For example, content delivery channel 132 may be associated with a first measure of effectiveness across all campaigns, a second measure of effectiveness across campaigns involving computer products, and a third measure of effectiveness with respect to a particular content targeting campaign indicated in campaign database 114.

Campaign information stored in campaign database 114 may also include performance data upon which measures of effectiveness may be calculated. Again, such campaign information may be on a per-campaign basis and/or across multiple campaigns, such as a strict subset of all the campaigns or all the campaigns. For example, content delivery channel 132 has resulted in 1,256 leads in the last month across all campaigns indicated in campaign database 114.

### Content Delivery Channels

Content delivery channels 132-136 are configured to receive resource allocation data from resource allocation service 110 and, based on the received resource allocation data, provide targeted content to one or more client devices, such as client device 140. Client devices request content from each of content delivery channels 132-136. In each response, each of content delivery channels 132-136 is configured to provide the requested content and content provided by resource allocation service 110 and/or the campaign initiator(s).

Examples of content delivery channels 132-136 include social network providers (e.g., LinkedIn, Facebook, Google+), news websites, sports and entertainment websites, blogs, and other content providers. For example, resource allocation service 110 provides allocation data and targeted content (e.g., an advertisement) to a social network provider. When a user employing client device 140 logs into the social network provider, the social network provider identifies the targeted content and sends the targeted content, along with user profile information, to client device 140.

### Client Device

Each of client devices 140, 142 is a computing device, including but not limited to, a work station, a personal computer, a general purpose computer, a laptop, an Internet appliance, a hand-held device, a wireless device, a wired device, a portable or mobile device, a wearable computer, a cellular or mobile phone, a portable digital assistant (PDA), a smart phone, a tablet computer, a multi-processor system, microprocessor-based or programmable consumer electronics, a game console, a set-top box, a network PC, a mini-computer, and the like. Each of client devices 140, 142 may include applications, software, and/or other executable instructions to facilitate communication with content delivery channels 132-136.

### Initial Resource Allocation Settings

In an embodiment, a set of resources is allocated across content delivery channels 132-136. As described previously, the allocation may be pre-defined or established by a campaign initiator (in cases where resource allocation service 110 does not provide the resources to be allocated). Table A is an example set of resource allocation settings.

TABLE A

| Channel 1 | Channel 2 | Channel 3 |
|---|---|---|
| 50% | 50% | Channel not present |
| 40% | 40% | 20% |
| Channel not present | 67% | 33% |
| 67% | Channel not present | 33% |

Each row in Table A refers to a different scenario and the percentage (%) represents a split of a (e.g., daily) budget across multiple channels. In some scenarios, one of the channels is not available or possible for the resource-originating party, such as the campaign initiator.

Regardless of how the initial resource allocation settings for a content targeting campaign are established, over time the settings change to reflect current (and/or predicted future) conditions.

A pre-defined resource allocation setting may be based history data indicating how well each channel has performed in the past. For example, if channel 1 is performing twice as well as channel 2, then ⅔ of the resources will be allocated to channel 1 and ⅓ of the resources will be allocated to channel 2.

### Resource Utilization Caps

In an embodiment, resource allocation data provided to a content delivery channel indicates a limit on an amount of resources for the content delivery channel to use to provide targeted content (e.g., creatives) to client devices. The limit may be a daily limit, a weekly limit, or some other time-based limit. For example, resource utilization data sent to content delivery channel 132 indicates that content delivery channel 132 is to spend no more than $100 each day delivering a particular advertisement to client device 140 and to client devices that are operated by users considered similar to the user of client device 140. Any leftover amount may simply go unused (and, thus, never used by a content delivery channel) or may be applied to a subsequent time period, such as the next day.

Alternatively, the limit indicated in resource allocation data may simply be a resource amount. For example, resource allocation data indicates $100 and, once content delivery channel 132 uses that amount (regardless of how long it takes) in delivering a particular advertisement, content delivery channel 132 will not deliver that particular advertisement anymore.

### Process Overview

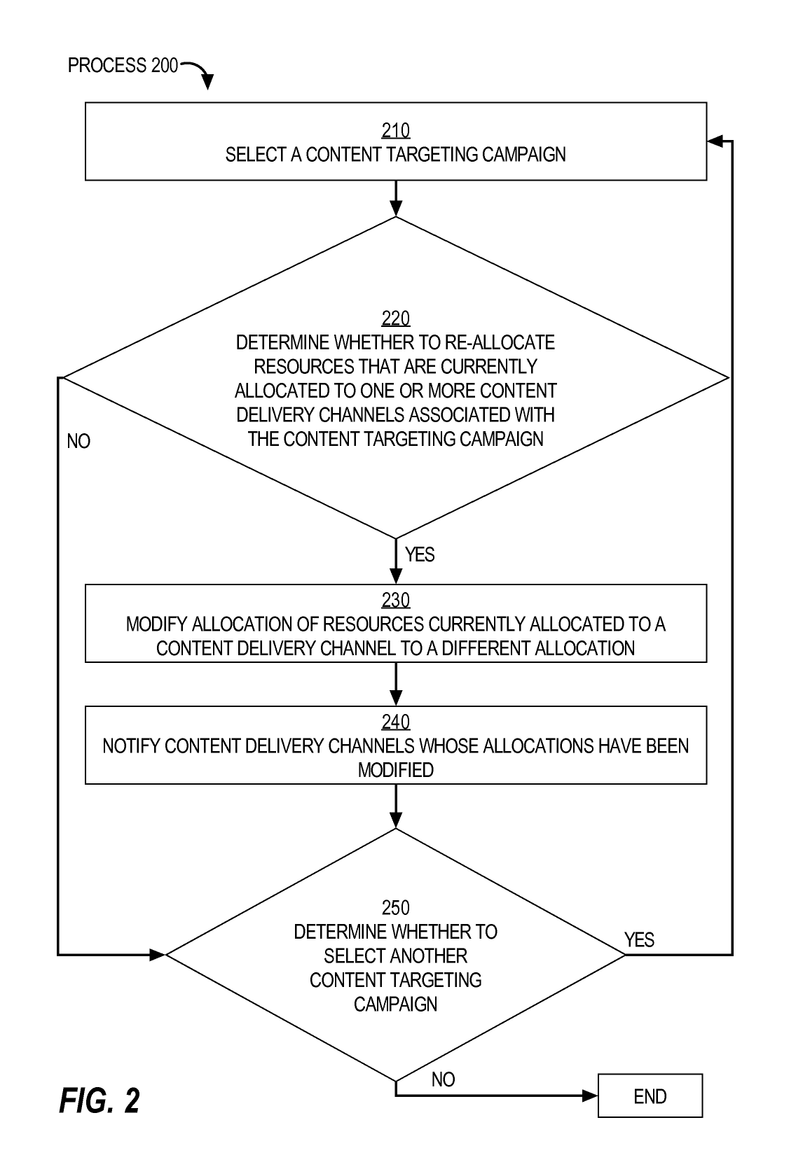

FIG. 2 is a flow diagram that depicts a process 200 for dynamically re-allocating resources among multiple content delivery channels, in an embodiment. Process 200 may be performed by re-allocation component 112.

At block 210, a content targeting campaign is selected. If resource allocation service 110 manages multiple content targeting campaigns, then one or more criteria may be used to select a content targeting campaign. For example, the content targeting campaign that has not been considered for re-allocation for a longer period of time relative to other content targeting campaigns is selected. As another example, the content targeting campaign that had a re-allocation that satisfied certain criteria (e.g., changed allocation of a content delivery channel by more than 30%) is selected.

Block 210 may be performed in response to determining that one or more campaign analysis criteria of a campaign are satisfied. For example, re-allocation component 112 periodically (e.g., every eight hours or every day) checks campaign analysis criteria associated with each content targeting campaign.

In a related embodiment, re-allocation component 112 subscribes to event notifications that indicate that certain events associated with one or more content targeting campaigns have occurred. In this embodiment, resource allocation service 110 receives event notifications and determines which content targeting campaign to select.

At block 220, it is determined whether a current allocation of resources to one or more content delivery channels associated with the content targeting campaign should be changed. This determination may be made in one of multiple ways and based on one or more criteria being satisfied. For example, block 220 may involve comparing measures of effectiveness of different content delivery channels to determine which channel is performing better or which is under-performing according to one or more performance criteria. This is referred to as a “channel performance check” and is described in more detail below under the “performance rule.” Additionally or alternatively, block 220 may involve determining whether any content delivery channel associated with the content targeting campaign is not utilizing a set of resources that are currently allocated to that channel. This is referred to as an “unconsumed resource check” and is described in more detail below.

If the determination in block 220 is positive, then process 200 proceeds to block 230. Else, process 200 proceeds to block 250.

At block 230, the current allocation of resources to one or more content delivery channels is modified to a different allocation of resources to the one or more content delivery channels. Block 230 may involve a fixed re-allocation of resources from one channel or another. For example, 20% of resources previously allocated to a lower performing channel is re-allocated to a higher performing channel. Alternatively, block 230 may involve a re-allocation that is commensurate with a difference in performance metrics of two channels and may take into account current allocation levels and/or other metrics. For example, if channel 132 is performing better than channel 134 by only 10%, then only 10% of resources that are allocated to channel 134 are re-allocated to channel 132. In a related example, if channel 132 is rarely consuming its daily budget, then only 5% (instead of 10%) of resources allocated to channel 134 are re-allocated to channel 132.

At block 240, each content delivery channel whose resource allocation is modified is notified of the modification. Block 240 may involve re-allocation component 112 (1) sending, to content delivery channel 132, first modification data that indicates a first new resource allocation setting and (2) sending, to content delivery channel 134, second modification data that indicates a second new resource allocation setting. The first and second modification data may also identify the content targeting campaign that is involved so that content delivery channels 132, 134 know which creatives are affected.

At block 250, it is determined whether another content targeting campaign should be selected. If so, then process 200 returns to block 210. Else, process 200 ends.

### Re-Allocation Rules

In an embodiment, the adjustment of resource allocation settings of a campaign is performed based on one or more rules, which may indicate when, whether, or how much to re-allocate a set of (unconsumed) resources. Example rules include an unconsumed budget rule, a new account rule, a new channel rule, a performance rule, and a minimum budget rule. Rules may be defined by resource allocation service 110 and/or campaign initiators. Thus, the rules applicable to one content targeting campaign may be the same as, or different than, the rules applicable to another content targeting campaign.

### Rule: Unconsumed Resources

If one content delivery channel has not used a certain amount of its allocated resources, then a particular amount of the allocated (future) resources are (re-)allocated to another content delivery channel. For example, if channel 132 has not consumed over 20% of its budget, then 70% of the leftover is allocated to channel 134.

This rule may include another condition that the channel to which resources are being re-allocated needs to be using up the resources allocated to that channel. In the example above, 70% of the leftover resources of channel 132 are re-allocated to channel 134 only if channel 134 has been using up the resources allocated to it for the last three consecutive days. Otherwise, no re-allocation occurs.

### Rule: New Account

If a new campaign initiator is introduced, then the set of resources that the new campaign initiator gives to resource allocation service 110 may be allocated according to, for example, a pre-defined resource allocation setting, such as one of the settings in Table A. Alternatively, the new campaign initiator may provide one or more of the resource allocation settings.

### Rule: New Channel

In one scenario, resource allocation service 110 may have already allocated resources to channels 132 and 134 for a particular content targeting campaign. Later, channel 136 is added as a possibility. Channel 136 may not have existed before the initial allocation to channels 132 and 134. Alternatively, the corresponding campaign initiator may not have wanted to initially use channel 136, but has since indicated a desire to use channel 136. Either way, channel 136 is considered “new”, at least with respect to the corresponding content targeting campaign that previously did not use content delivery channel 136.

In an embodiment, a new content delivery channel for a particular content targeting campaign is assigned a particular amount of resources, such as a fixed amount/day (e.g., $300/day) or a percentage (e.g., 10%). The particular amount of resources may be re-allocated from existing content delivery channels using different techniques. In one technique, the ratio between the allocation of the existing channels is retained after an allocation to a new content delivery channel. For example, initially, 33% of resources are allocated to channel 132 and 66% of resources are allocated to channel 134. When channel 136 is introduced as an option for the corresponding content targeting campaign, 10% of the resources are allocated to channel 136 while 30% is allocated to channel 132 and 60% is allocated to channel 134 (thus, maintaining a 1-to-2 ratio between channel 132 and channel 134).

In another technique, only resources allocated the poorest performing channel are re-allocated to a new content delivery channel. For example, initially, 60% of resources are allocated to channel 132 and 40% of resources are allocated to channel 134. When channel 136 is introduced as an option for the corresponding content targeting campaign, 10% of the resources are allocated to channel 136. It is determined that channel 132 is the poorest performing of the two channels. Thus, after the re-allocation, 50% (60%-10%) is allocated to channel 132 and 40% is (still) allocated to channel 134.

The amount of resources allocated to a new content delivery channel may be different for different content targeting campaigns. For example, the new content delivery channel may be allocated only 5% of resources corresponding to a first campaign and 10% of resources corresponding to a second campaign. The difference in allocations may be based on one or more criteria. For example, when a new content delivery channel is introduced for a first campaign, very little information may be known about the new channel. Later, when more is known about the new channel and its relative success and the new channel is introduced for a second campaign, then, for the second campaign, more (e.g., relative) resources may be assigned to the new channel.

As another example, a new channel may be associated with a certain type of content (e.g., video or audio) or with a certain class of products/services. Different content targeting campaigns may be associated with different types of content or with different classes of products/services. For example, if a campaign is regarding a first type of product and a new content delivery channel generally attracts users who are interested in the first type of product, then the new content delivery channel may be allocated 20% of the resources (as opposed to 10% or less).

### Rule: Performance

In an embodiment, relative performance among existing content delivery channels is used to determine how much (or when) to re-allocate resources among the channels. Generally, the better a content delivery channel performs, the more resources will be re-allocated to that content delivery channel. For example, if channel 132 is performing better than channel 134, then at least a portion of resources previously allocated to channel 134 is re-allocated to channel 132.

A content delivery channel is associated with one or more measures of effectiveness. Which measure of effectiveness of a content delivery channel is used may vary depending on the needs or interests of the campaign initiator(s). A campaign initiator may be interested in the number of certain actions that are performed relative to a creative, such as an advertisement. Examples of actions include “likes” (referring to a number of times users indicated that they liked a creative or set of creatives), clicks (referring to a number of times users have clicked on, or otherwise selected, a creative or set of creatives), conversions (such as purchases of a product or service or another intended action of a content targeting campaign), or leads.

A “lead” refers to a user that provides input that allows another party (such as the corresponding campaign initiator) to view personal information of user, such as a profile of the user in a social network. For example, a user, after viewing a creative, may fill out a form that asks for the user's name, email address, mailing address, phone number, employment history, academic history, skills, and/or personal interests. As another example, instead of filling out a form, a user selects a button that causes the user's profile information from a social network to be sent to (or “shared with”) the corresponding campaign initiator. In this example, resource allocation service 110 may be part of the social network or may be part of a different platform than the social network.

Thus, “actions” that are tracked may refer to what a content delivery channel has primary control over (such as impressions) or to what a user does, such as fill out a form, click on a creative, or “like” a creative.

A campaign initiator may also be interested in how many resources are used per action that is performed. Examples of such measures of effectiveness include cost-per-action (CPA) or, more specifically, cost-per-lead (CPL), cost-per-click (CPC), and/or cost-per-impression (CPI). For example, if $100 is allocated to channel 132 in a particular month and two leads are found through channel 132, then the CPL for channel 132 is $50 per lead.

In an embodiment, a single measure of effectiveness takes into account multiple types of actions. For example, content delivery channel 132 may be credited for 1,000 clicks on a creative presented by content delivery channel 132 and 2,000 “likes,” both of which occurred over a particular period of time. Re-allocation component 112 calculates a measure of effectiveness based on (1) the number of resources allocated to content delivery channel 132 during that particular period of time and (2) 3,000 (i.e., 1,000+2,000).

Another example measure of effectiveness of a content delivery channel is cost-per-visitor (CPV). CPV may be calculated by looking at average unique visitors to a web site per day before a content targeting campaign and average unique visitors per day after the content targeting campaign has begun. It may or may not be determined how the unique visitors arrived at a web site. If not, then CPV is a rough measure on how effective a content targeting campaign is since any increase in traffic to the web site may be attributed to factors other than the creative(s) presented through the content delivery channel.

Another example measure of effectiveness of a content delivery channel is cost-per-lead stage (CPLS). Once a lead is found, the lead should be “nurtured” toward performing a particular action, which may be the focus of a content targeting campaign. The process of a lead advancing to the particular action may be divided into multiple stages, one stage leading to another. Example stages include early discussions, RFP (request for proposal) or active discussions, negotiation and review, closing, and delivery. A campaign initiator may desire to reach, or at least view, a channel's CPLS. For example, resource allocation service 110 may record (1) a first CPLS for advancing from a first stage to a second stage in a sales process and (2) a second CPLS for advancing from the second stage to a third stage in the sales process. Each stage may be associated with a different set of content delivery channels and/or different resource allocations.

### Reporting Actions

Depending on the type of action, a content delivery channel may report certain actions that users performed relative to one or more creatives. For example, content delivery channel 132 may record that client device 140 displayed a creative provided through content delivery channel 132. Thereafter, content delivery channel 132 sends, to resource allocation service 110, report data that indicates a particular creative (which may be associated with a particular content targeting campaign), that a client device displayed the particular creative. The report data may even include client device or user identifiers that identify the users that viewed (or the client devices that displayed) the corresponding creative.

Other types of actions may be determined by resource allocation service 110 or by a campaign initiator. For example, a user of client device 140 selects an advertisement displayed by content delivery channel 132. The advertisement includes a URL that includes channel identification data that is associated with content delivery channel 132. In response, a web browser executing on client device 140 uses the URL to access a web site provided by the campaign initiator and passes the channel identification data to a web server hosting the web site. The campaign initiator determines, based on the channel identification data, that client device 140 accessed the web site through content delivery channel 132. The URL may also include campaign identification data that indicates with which content targeting campaign the advertisement is associated. Campaign identification data is helpful in cases where a campaign initiator has initiated multiple content targeting campaigns that are running simultaneously and desires to know how each content delivery channel is performing on per-campaign basis.

If a campaign initiator is different than the entity that owns or operates resource allocation service 110 and the campaign initiator calculates determines some metrics associated with a content delivery channel (e.g., number of leads, views, or clicks), then the campaign initiator reports the metrics to resource allocation service 110 manually or automatically. resource allocation service 110, in turn, calculates measures of effectiveness of the content delivery channel based on the reported metrics.

### Rule: Minimum Resource Allocation

In an embodiment, a minimum resource allocation is set, such that a resource allocation to a channel cannot be any lower than a particular amount. For example, a minimum resource allocation for a channel may be $100. As another example, a minimum resource allocation for a channel may be 10% of a total budget.

If a minimum resource allocation rule is applicable, then other resource allocation rules that are applied may be negated. For example, a performance rule, if applied, may reduce a current allocation of 10% of a budget for content delivery channel 132 to 6% of the budget. However, a minimum resource allocation rule may be that no channel is to be allocated less than 10% of a budget.

A minimum resource allocation rule may be applied: (1) across all channels, regardless of the content targeting campaign; (2) across all channels of a particular set of one or more content targeting campaigns; (3) for a particular channel, regardless of the content targeting campaign; or (4) for a particular channel for a particular set of one or more content targeting campaigns.

### An Allocation Approach

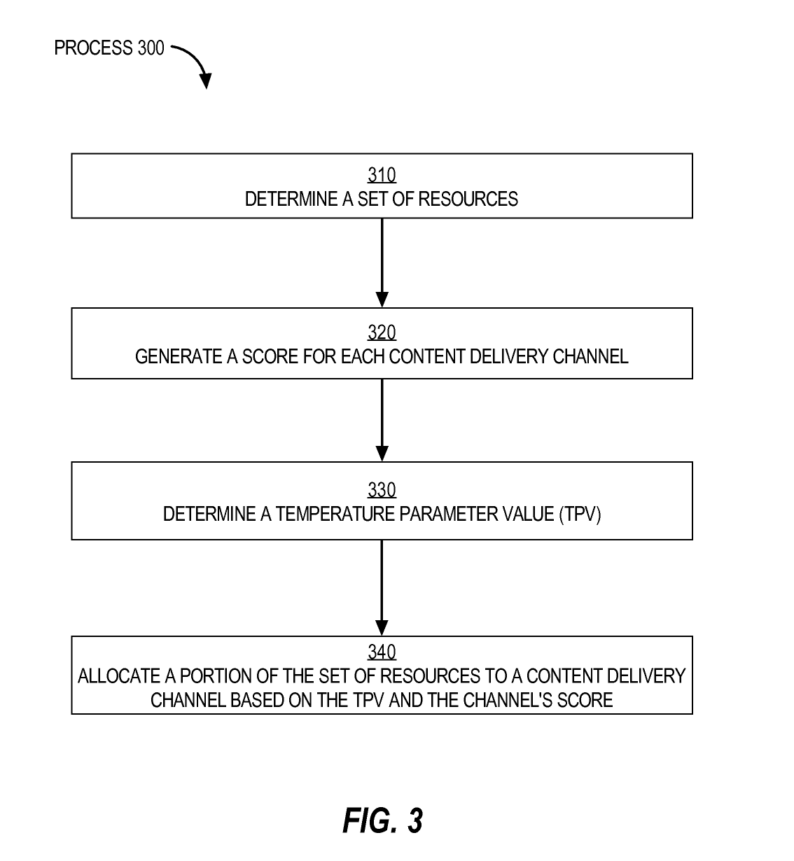

FIG. 3 is a flow diagram that depicts a process 300 for allocating resources to multiple content delivery channels, in an embodiment. Process 300 may be performed for an initial resource allocation for a particular content targeting campaign. Alternatively, process 300 may be performed for a re-allocation for an existing content targeting campaign. Process 300 may be performed by re-allocation component 112 or by another component of resource allocation service 110.

At block 310, a set of resources is determined. The set of resources may have been yet to be allocated or may have already been allocated to one or more content delivery channels.

At block 320, a score is generated for each of multiple content delivery channels. The score indicates a measure of efficiency or effectiveness associated with the corresponding content delivery channel. Examples of effectiveness include CPA (described previously) and ROI (or return-on-investment) associated with each content delivery channel. An ROI is an inverse of a measure of effectiveness, described previously. For example, an ROI for a content delivery channel may be number of leads per dollar spent, such as 3 per $100, or a number of clicks per dollar spent, such as 20 per $50.

Also, the score may be based on events that occurred during a particular period of time, such as 30 days. In other words, a score for a content delivery channel is based on how that channel performed (or how effective that channel was) during the last the 30 days. The size of the time window and the time window itself may change automatically or based on user input. For example, the time window may be changed from 30 days to 34 days and that 34-day window does not include the most recent five days.

At block 330, a value for a particular parameter is determined. The particular parameter is referred to herein as the “temperature parameter.” The value of the temperature parameter dictates how much effect the score for a content delivery channel has on determining an allocation to the content delivery channel. The higher the value (or as the temperature parameter value increases), the more uniform the resources are allocated to each content delivery channel. For example, if there are three content delivery channels, then each content delivery channel will be allocated approximately 33% of the (remaining) resources.

Conversely, as lower the value (or as the temperature parameter value decreases), the more the resources are allocated to each content delivery channel based on the score. For example, if there are three content delivery channels and the score of a first channel is 10, a second channel is 20, and a third channel is 40, then the first channel may be allocated approximately 14%, the second channel may be allocated approximately 30%, and the third channel may be allocated approximately 56% of the (remaining) resources.

At block 340, an allocation is determined for each content delivery channel based on the score of the content delivery channel and the temperature parameter value. An example allocation equation that may be used to determine an allocation for a set of content delivery channels and that includes the temperature parameter is as follows:

A(chᵢ)=score(chᵢ)^{1/T}/Σⱼscore(chⱼ)^{1/T}

In this equation, the function “score” takes into account one or more attributes or characteristics of a content delivery channel, such as its current effectiveness, a difference between post-click and post-view conversions, etc. Thus, the function “score” may be simple or arbitrarily complex. The variable ‘i’ refers to a particular content delivery channel and the sum (Σⱼ) is over the scores of all content delivery channels. Thus, the allocation to one content delivery channel depends on scores of the other content delivery channels.

In this equation the parameter T dictates how much the score of a channel effects on an allocation to that channel. If T=0, then the allocation to each content delivery channel is in proportion to each channel's score. If the score of each channel is the same, then decreasing (or increasing) T has no effect on the resulting allocation. As T approaches 0, the differences in scores among the channels are amplified. For example, if there is a slight difference in scores among the channels, then, as T decreases from 1, a greater portion of the resources is allocated to the higher scoring channel(s). Conversely, the higher the value of T, the more uniform the distribution of resources among the channels. For example, even if one channel has a score that is five times greater than the other channel, each channel may be allocated roughly the same amount of resources when T is relatively high, such as greater than ten.

In an embodiment, how many resources a content delivery channel is allocated is based on that channel's “spending capability.” A channel's “spending capability” refers to an amount (e.g., maximum amount) of resources that the channel is able to spend. A channel's spending capability may be estimated from past spending data, which may be on daily, monthly, or other time period basis. For example, channel 132 may have been allocated $100/day in the past, but the highest it ever spent in a single day was $91. Thus, channel 132's spending capability is $90 or $90 per day.

A channel's spending capability may act as a ceiling on the amount of resources allocated to the channel. For example, if a channel, based on the channel's score and current temperature parameter value, is to be allocated $200, but the channel's spending capability is $150, then the channel is allocated $150. Alternatively, a channel's spending capability may be used to identify a higher ceiling on the amount of resources allocated to the channel. For example, a channel is allocated nor more than 15% than the channel's spending capability. For example, if a channel's spending capability is only $150, then the channel is allocated no more than ($150*115%=) $172.50.

Process 300 may be performed multiple times for the same content targeting campaign. Each subsequent iteration of process 300 may involve (a) the same temperature parameter value (TPV) but different channel scores (e.g., due to updates in measures of effectiveness of one or more of the content delivery channels), (b) a different TPV than the previous TPV but the same channel scores as the previous iteration, or (c) a TPV and different channel scores relative to the channel scores in the previous iteration. For example, for the first iteration of process 300 for a particular content targeting campaign, the value of T is ten; for the second iteration of process 300 for the particular content targeting campaign, the value of T is two; and for the third iteration of process 300 for the particular content targeting campaign, the value of T is one.

A TPV may be set or established for multiple (or all) content targeting campaigns that resource allocation service 110 manages, regardless of the campaign initiators of the content targeting campaigns. Additionally or alternatively, a TPV is set or established on a per-campaign initiator basis. For example, a first campaign initiator may be associated with a first TPV (e.g., three) and a second campaign initiator may be associated with a second TPV (e.g., 0.5).

In a related embodiment, a TPV is established on a per-campaign initiator type basis. For example, campaign initiators (and, thus, their corresponding campaigns) are grouped based on type, such as campaign initiators involved in software technology, campaign initiators involved in travel services, campaign initiators involved in restaurant services, and campaign initiators involved in car manufacturing. Thus, the TPV value associated with campaigns related to travel services changes independently of the TPV value associated with campaigns related to car manufacturing.

Additionally or alternatively, a TPV is set or established on a per campaign basis. For example, if a single campaign initiator initiated two content targeting campaigns, then each content targeting campaign may be associated with different TPVs.

### Determining the Temperature Parameter Value

The value of a temperature parameter may be determined manually based on user input or automatically or both. For example, an administrator of resource allocation service 110 may provide a default or initial value for the temperature value and then later update the value prior to exhaustion of resources for the content targeting campaign. Alternatively, the initial TPV may set to ten and then, over time, as performance data for one or more of content delivery channels is retrieved and analyzed, the TPV automatically decreases.

One or more criteria may be used to automatically determine a new or updated TPV. Examples include amount of data regarding a particular content targeting campaign, a content delivery channel, and other campaigns of a similar type. For example, if little (to zero) effectiveness information is known about a new content delivery channel, then the value of T may initially be high, such as twenty. Thus, even though the new content delivery channel may have a low score, the new content delivery channel will be allocated roughly the same amount of resources as other content delivery channels for the same content targeting campaign.

As another example, if the campaign initiator of a content targeting campaign is new to resource allocation service 110 such that resource allocation service 110 has not previously managed a content target campaign from the campaign initiator, then the TPV may be initially set relatively high. As more information about how each content targeting campaign is performing, the TPV may be lowered. Additionally, if the change in effectiveness of one or more content delivery changes is relatively low over a period of time (e.g., less than 5% change in CPA each week for the last two weeks), then the TPV is lowered. The amount the TPV is lowered may be lock step (e.g., one or two points at each reassessment, or the TPV is lowered such that the difference between the current TPV and the new TPV is the same as the difference between the new TPV and one). Alternatively, the amount the TPV is lowered may be based on how much a channel's score changes over time. If there is very little change in a channel's score, then T may be lowered to one and even to a value less than one.

One or more criteria may be used to determine whether to keep a TPV relatively high (and, thus, keep a relatively uniform distribution of resources among the content delivery channels. For example, if the effectiveness of one or more content delivery channel changes relatively significantly over a period of time (e.g., greater than 15% change in CPA each day for five days) for a particular content targeting campaign, then the TPV remains relatively high, such as over two.

Process 300 involves an approach for allocating resources among multiple content delivery channels. Process 300 may be performed regularly, such as every day, every week, or in response to detection of an event in a set of events.

### Determine Whether to Perform a Re-Allocation

In an embodiment, a re-allocation determination is made regarding whether to perform a re-allocation. This determination is made regardless of how an allocation for each content delivery channel is determined (e.g., with a TPV or without a TPV and/or regardless of the score function). An affirmative re-allocation determination may be a necessary condition before performing process 300 or something similar.

One way to determine whether to perform a re-allocation is considering a statistical significance of the measures of effectiveness of respective content delivery channels. That is, resources are shifted from channel A to B if the difference in their respective measures of effectiveness (e.g., CPL) is significant with confidence α (e.g., 95%). This will allow content targeting campaigns with higher volume to be adjusted more frequently.

Statistical significance is used to determine whether a null hypothesis should be rejected or retained. A null hypothesis is the general or default statement that nothing happened or changed. For a null hypothesis to be rejected as false, the result has to be identified as being statistically significant or, in other words, it is unlikely that the result to have occurred due to sampling error alone.

To determine whether a result is statistically significant, a p-value is calculated. The p-value is the probability of observing an effect given that the null hypothesis is true. The null hypothesis is rejected if the p-value is less than the significance or a level. The a level is the probability of rejecting the null hypothesis given that it is true (type I error) and may be set at any value, such as 0.05 (or 5%). If the a level is 0.05, then the conditional probability of a type I error (i.e., given that the null hypothesis is true) is 5%. Then, a statistically significant result is one in which the observed p-value is less than 5%.

One way to conduct a test of significance is a permutation test. In an embodiment, a permutation test involves: (1) calculating a first difference in the cost per conversion (e.g., CPL) between two channels based on a set of events; (2) relabeling the set of events; and (3) calculating a second difference in the cost per conversion (e.g., CPL) between the two channels based on the relabeled set of events. An event may be represented by the triplet (channelId, cost, conversion). Examples of conversions include impressions and clicks, which may not be considered conversions themselves but at least resulted in conversions.

For the first step in the permutation step, a difference in cost per conversion may be calculated as follows:

δ=Σ_{channelID}_{ᵢ}_{=A} costi/Σ_{channelID}_{ᵢ}_{=A} conversioni−Σ_{channelID}_{ᵢ}_{=B} costi/Σ_{channelID}_{ᵢ}_{=B} conversioni

In this formula, the cost of each event of channel A is summed and then divided by the sum of each conversion of each event of channel A. Similarly, the cost of each event of channel B is summed and then divided by the sum of each conversion of each event of channel B. The difference between the results of the division is calculated and represented as 5 in the above example formula.

For the second step in the permutation test, a set of events is randomly relabeled. The set of events may include events associated with channel A and events associated with channel B. Relabeling an event involves switching a channelId of one channel with a channelId of another channel. For example, if there are two channels (channels A and B), then, after relabeling, one or more events that were associated with channel A are relabeled to be associated with channel B and/or vice versa. The proportion of events associated with each channel before a relabeling is retained (exactly or at least roughly) after the relabeling. For example, if 40% of events are associated with channel A and 60% of the events are associated with channel B, then, after relabeling, 40% of the events are still associated with channel A and 60% of the events are still associated with channel B, except that some events that were associated with channel A are now associated with channel B and vice versa.

For the third step in the permutation test, after one or more events of each channel are relabeled, a difference Δ in cost per conversion is recalculated based on the events that were relabeled and events that were not relabeled. The p-value of the permutation test is given by the probability P{Δ>δ}. If P{Δ>δ} is sufficiently small, then a reallocation will occur. P{Δ>δ} is calculated by repeating the permutation test multiple times (e.g., a thousand times). After the permutation test is performed a time of times, a count of the number of times where, Δ>δ is satisfied is determined. The count is then divided by the total number of times the permutation test was performed.

To determine which pair of channels should shift budget, all channel pairs with p-value<(1−α) are identified, and among those pairs the one with the largest Δ (performance difference) is selected.

In an embodiment, after it is determined that resources will be re-allocated from one channel to another, instead of using a fixed percentage to shift (e.g., 20%), the minimum change that will make the difference in cost per conversion to be statistically insignificant is calculated. The amount of resources to re-allocate from one channel to the other is done so that the resulting allocation is proportional to the observed conversions (e.g., leads) or other measure of effectiveness. For example, Bᵢ and A are budgets allocated to channels cᵢ and cⱼ, respectively; B′ᵢ and B′ⱼ are new budgets to be allocated to channel cᵢ, and cⱼ, respectively; and conversion, and conversionⱼ are the conversions on channel cᵢ and cⱼ, respectively.

B′ᵢ+B′ⱼ=Bᵢ+Bⱼ and

B′ᵢ/B′ⱼ=conversionᵢ/conversionⱼ

Solving the above equations results in new budgets B and B being calculated. This change can be further capped by a predefined limit, such as 20% of the overall (e.g., daily) budget. By making a conservative move at each step, over-adjusting and moving the budget back and forth between the channels can be avoided.

### Allocation Among Nurture Flows

In an embodiment, resource allocation service 110 manages one or more nurture flows for a campaign initiator. A nurture flow is a plan for targeting content, such as creatives, to a set of one or more users whose identities may be known or unknown. A nurture flow is divided into progressive segments (or steps) that funnel a user toward performing a particular action, referred to herein as the “intended action.” An example of a plan is a marketing plan and examples of an intended action include viewing certain video content, listening to certain audio content, making a donation to a charitable cause, or performing a conversion (or purchase) on a website. Nurture flows and nurture flow creation and management are described in U.S. patent application Ser. No. 14/815,873, which is incorporated by reference herein.

In an embodiment, resource allocation service 110 allocates resources on a per-nurture flow basis instead of a per-campaign basis. Each stage in a nurture flow may correspond to a different campaign. Thus, if a user is assigned to a first stage in a nurture flow, then a first set of creatives corresponding to a first campaign are targeted to a client device of that user. If the user is assigned to a second stage in the nurture flow, then a second set of creatives corresponding to a second campaign are targeted to a client device of that user. The first set of creatives are provided to a first set of content delivery channels and the second set of creatives are provided to a second set of content delivery channels, which may be the same as or different than the first set of content delivery channels.

In this embodiment, resource allocation service 110 receives resources from a nurture flow initiator and determines how to allocate the resources among different stages (corresponding to different content targeting campaigns) of a nurture flow. Thus, one stage of a nurture flow may be allocated more resources than another stage of a nurture flow. Even if two stages of nurture flow are allocated the same amount of resources, the distribution of the resources to content delivery channels of the one stage may be different than the distribution of the resources to content delivery channels of the other stage. For example, $200/day is allocated to a first stage of a nurture flow and $200/day is allocated to a second stage of the nurture flow. In the first stage, $130 of the $200 is allocated to content delivery channel 132 while $70 of the $200 is allocated to content delivery channel 134. In the second stage, $90 of the $200 is allocated to content delivery channel 132 while $110 of the $200 is allocated to content delivery channel 134. In a related example, the $110 is allocated to content delivery channel 136 instead of channel 134.

Thus, the same re-allocation techniques described herein that involve changes on a per-campaign basis may be applied on a per-nurture flow basis.

In a related embodiment, a nurture flow initiator may initiate multiple nurture flows. The nurture flow initiator may provide a single amount of resources to resource allocation service 110 to manage all the nurture flows. Thus, resource allocation service 110 determines how much to allocate and/or reallocate the resources among the multiple nurture flows and, for each nurture flow, among the stages of the nurture flow.

### Re-Allocation Frequency

Resource allocation may be triggered manually (i.e., based on user input) or automatically. For example, a person reviewing current performance trends of each channel for a particular content targeting campaign (or for multiple campaigns managed by resource allocation service 110) may determine that a re-allocation is warranted and, accordingly, provide, to resource allocation service 110 (or a representative thereof), input indicating that preference.

As another example, a campaign initiator may desire to change the allocation of its resources. In this example, the campaign initiator provides, to resource allocation service 110, input that indicates a different setting for each existing channel (or for more or less than the channels that are currently used for the corresponding content targeting campaign).

In an embodiment, resource allocation service 110 determines whether to re-allocate a set of resources for a particular content targeting campaign on a time-based schedule, such as every one day or fifteen days. In a related embodiment, a re-allocation determination varies depending on the type of measure of effectiveness. For example, if a content delivery channel's effectiveness is based on CPL, then a re-allocation determination is made after (or every) fifteen days. If a content delivery channel's effectiveness is based on CPC, then a re-allocation determination is made after (or every) two days.

Alternatively, resource allocation service 110 determines whether to re-allocate a set of resources for a particular content targeting campaign on a per event basis. For example, performance of each channel is monitored periodically, such that one or more performance metrics for each channel are generated frequently, such as every three hours. Even though resource allocation service 110 may automatically apply one or more of the above-described rules every ten days, resource allocation service 110 may apply one or more of the rules (e.g., the performance rule or the unconsumed resources rule) if a performance metric for one or more channels drop below or above a particular threshold, such as 30% unconsumed resources in one channel or a difference in CPA of two channels by more than twenty.

In an embodiment, in a time-based scenario, the frequency with which a re-allocation is determined and/or performed changes over time. For example, for a new content targeting campaign, resource allocation service 110 determines whether to perform a re-allocation after fifteen days. After the first fifteen days (i.e., after performance data from each of the content delivery channels is received), resource allocation service 110 determines whether to perform a re-allocation every seven days.

### Intra-Channel Allocation

A content delivery channel may allow targeted content to be provided to client devices 140, 142 through multiple ways. For example, content delivery channel 132 provides creatives on multiple pages of a web site. As another example, content delivery channel 132 provides creatives on multiple locations of a web page or view provided by a web browser or a dedicated application (or “app”). Each page and/or location is referred to herein as a “mini-channel.”

In an embodiment, resource allocation service 110 may further allocate a set of resources (that are already allocated to a particular content delivery channel) to a set of mini-channels within the particular channel. For example, resource allocation service 110 allocates 50% of a $200 budget (already allocated to a content delivery channel) to a top location on a home page of content delivery channel 132, 30% of the $200 budget to a bottom location on the home page of content delivery channel 132, and 20% of the $200 budget on a second page (linked to by the home page) of content delivery channel 132.

A content delivery channel may provide metrics on a channel-wide basis and/or a mini-channel basis. Thus, resource allocation service 110 may use the metrics to determine initial intra-channel allocations to a content delivery channel and/or to determine a re-allocation of the initial intra-channel allocations.

### Campaign Management Compensation

In an embodiment where resource allocation service 110 is operated by a first entity and a campaign initiator is from a second entity, the first entity may compensate the second entity in one of multiple ways. Initially, the resources provided by the first entity may represent the total amount the first entity intends to pay for one or more content targeting campaigns. The second entity determines how to allocate funds to different content delivery channels and how much of the funds to retain for managing the content targeting campaign. For example, the second entity may retain 10% of the initial budget from the first entity and then determine how to allocate the remaining funds among multiple content delivery channels.

Alternatively, the second entity may indicate to the first entity that, based on the initial budget, one or more goals will be reached. If the second entity reaches the goal(s), then the second entity may retain any funds that were not used to reach the goal(s). For example, based on an initial budget of $60,000 from the first entity, the second entity promises that 1,000 leads will be found. If, by running the content targeting campaign, the second entity is able to help find 1,000 leads for under $60 per lead, then the second entity is able to retain the remaining funds.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

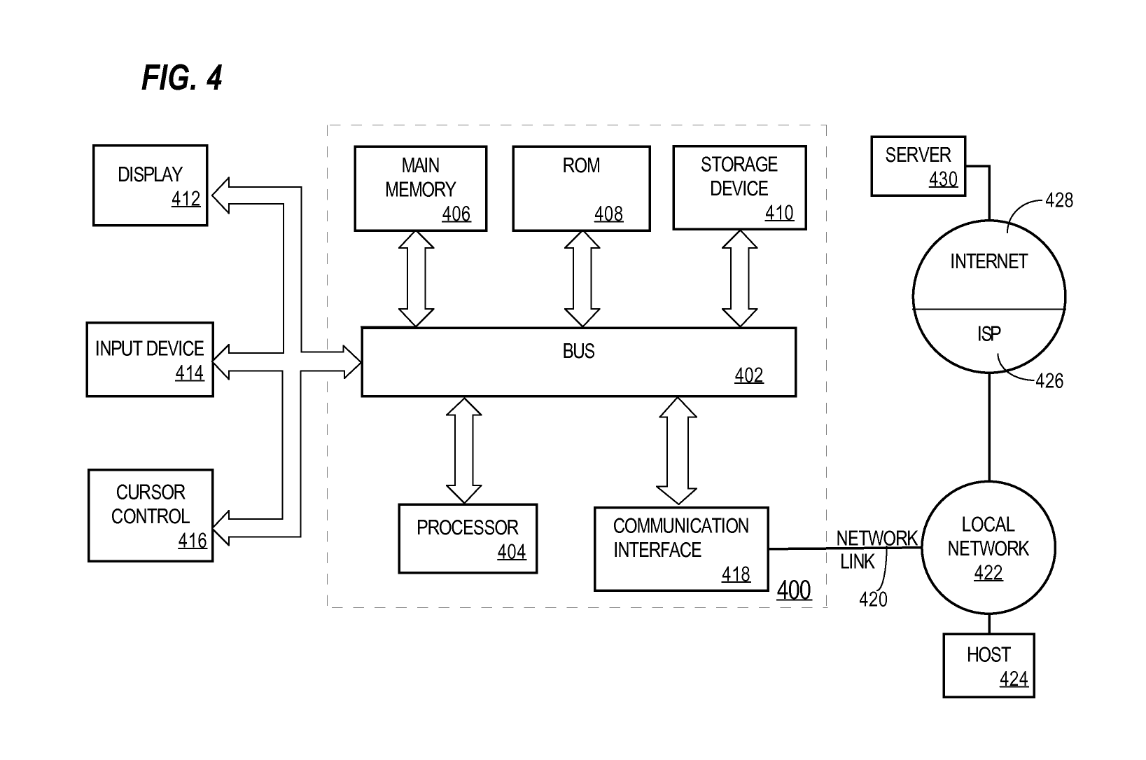

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a plurality of content delivery channels that includes a first content delivery channel and a second content delivery channel that is different than the first content delivery channel;
storing allocation data that indicates an allocation of a portion of resources to each content delivery channel of the plurality of content delivery channels;
wherein the allocation data indicates a first allocation of the resources to the first content delivery channel and a second allocation of the resources to the second content delivery channel;
prior to exhaustion of the resources:
determining, for each content delivery channel of the plurality of content delivery channels, a score for said each content delivery channel, wherein the score indicates a measure of efficiency associated with said each content delivery channel;
modifying the allocation data based on the score of each content delivery channel of the plurality of content delivery channels and a first value;
wherein as the first value increases, the more uniform the resources are allocated to each content delivery channel of the plurality of content delivery channels;
wherein as the first value decreases, the more the resources are allocated to each content delivery channel of the plurality of content delivery channels based on the score;
wherein the method is performed by one or more computing devices.

2. The method of claim 1, wherein the allocation data is first allocation data that is associated with a first campaign, the resources are first resources that are different than second resources, and the first value is of a particular parameter, the method further comprising:
storing second allocation data that indicates an allocation of a portion of the second resources to each content delivery channel of the plurality of content delivery channels;
wherein the second allocation data is associated with a second campaign that is different than the first campaign, wherein the second allocation data indicates a first particular allocation of the second resources to the first content delivery channel and a second particular allocation of the second resources to the second content delivery channel;
prior to exhaustion of the second resources:
determining, for each content delivery channel of the plurality of content delivery channels, a second score for said each content delivery channel, wherein the second score indicates a measure of efficiency associated with said each content delivery channel;
determining a second value of the particular parameter, wherein the second value is different than the first value;
modifying the second allocation data based on the second score of each content delivery channel of the plurality of content delivery channels and the second value;
wherein as the second value increases, the more uniform the second resources are allocated to each content delivery channel of the plurality of content delivery channels;
wherein as the second value decreases, the more the second resources are allocated to each content delivery channel of the plurality of content delivery channels based on the second score.

3. The method of claim 2, wherein modifying the second allocation data comprises:
modifying the second allocation data after modifying the first allocation data and prior to exhaustion of the first resources;
modifying the second allocation data without modifying the first allocation data based on the second value.

4. The method of claim 2, wherein the first campaign and the second campaign are initiated by the same party.

5. The method of claim 1, wherein:
the first value is of a particular parameter;
prior to determining the score, the first allocation and the second allocation were based on an initial value of the particular parameter;
the method further comprising, prior to determining the first value, receiving user input that indicates the first value;
the first value is different than the initial value.

6. The method of claim 1, the method further comprising, prior to modifying the allocation data, determining the first value of a particular parameter, wherein:
prior to determining the score, the first allocation and the second allocation were based on an initial value of the particular parameter;
determining the first value comprises automatically determining the first value based on one or more criteria and not based on user input.

7. The method of claim 1, wherein modifying the allocation data is performed by a first party that is different than a second party that owns or operates the first content delivery channel.

8. The method of claim 7, wherein the first content delivery channel is a third-party ad service.

9. The method of claim 1, further comprising:
prior to exhaustion of the resources and prior to modifying the allocation data, determining, based on one or more criteria, whether to modify the allocation data;
wherein modifying the allocation data comprises modifying the allocation data only in response to determining to modify the allocation data based on the one or more criteria;
wherein the one or more criteria indicates one or more of:
a certain amount of the first allocation is unconsumed,
a new content delivery channel that was not allocated any portion of the resources prior to determining whether to modify the allocation data, or
a first measure of effectiveness, associated with the first content delivery channel, being less than a particular threshold measure of effectiveness.

10. The method of claim 9, wherein the first measure of effectiveness is based on one of a number of leads that are attributable to the first content delivery channel, a number of clicks that are attributable to the first content delivery channel, a number of visitors, to a website, that are attributable to the first content delivery channel, a number of conversions that are attributable to the first content delivery channel, or a number of views, of particular content, that are attributable to the first content delivery channel.

11. A method comprising:
identifying a plurality of content delivery channels that includes a first content delivery channel and a second content delivery channel that is different than the first content delivery channel;
storing allocation data that indicates an allocation of a portion of resources to each content delivery channel of the plurality of content delivery channels;
wherein the allocation data indicates a first allocation of the resources to the first content delivery channel and a second allocation of the resources to the second content delivery channel;
determining a first measure of effectiveness of the first content delivery channel;
determining a second measure of effectiveness of the second content delivery channel;
determining a difference between the first measure of effectiveness and the second measure of effectiveness;
determining a statistical significance of the difference;
modifying the allocation data to generate modified allocation data that indicates a third allocation of the resources to the first content delivery channel and a fourth allocation of the resources to the second content delivery channel if it is determined that the difference is statistically significant;
wherein the method is performed by one or more computing devices;

12. The method of claim 11, wherein determining the statistical significance of the difference comprises:
identifying a first set of events that is associated with the first content delivery channel;
identifying a second set of events that is associated with the second content delivery channel;
associating a subset of the second set of events with the first content delivery channel to create a third set of events that are associated with the first content delivery channel;
associating a subset of the first set of events with the second content delivery channel to create a fourth set of events that are associated with the second content delivery channel;
determining, based on the third set of events, a third measure of effectiveness for the first content delivery channel;
determining, based on the fourth set of events, a fourth measure of effectiveness for the second content delivery channel;
determining a second difference between the third measure of effectiveness and the fourth measure of effectiveness;
wherein the statistical significance of the difference is based on the second difference.

13. The method of claim 11, wherein modifying the allocation data is performed by a first party that is different than a second party that owns or operates the first content delivery channel.

14. The method of claim 13, wherein the first content delivery channel is a third-party ad service.

15. The method of claim 11, wherein the first measure of effectiveness is based on one of a number of leads that are attributable to the first content delivery channel, a number of clicks that are attributable to the first content delivery channel, a number of visitors, to a website, that are attributable to the first content delivery channel, a number of conversions that are attributable to the first content delivery channel, or a number of views, of particular content, that are attributable to the first content delivery channel.

16. The method of claim 11, further comprising:
prior to exhaustion of the resources and prior to modifying the allocation data, determining, based on one or more criteria, whether to modify the allocation data;
wherein modifying the allocation data comprises modifying the allocation data only in response to determining to modify the allocation data based on the one or more criteria;
wherein the one or more criteria indicates one or more of:
a certain amount of the first allocation is unconsumed,
a new content delivery channel that was not allocated any portion of the resources prior to determining whether to modify the allocation data, or
the first measure of effectiveness, associated with the first content delivery channel, being less than a particular threshold measure of effectiveness.

17. The method of claim 16, wherein the one or more criteria are first criteria, further comprising, after modifying the allocation data to:
prior to exhaustion of the resources, determining, based on one or more second criteria that are different than the one or more first criteria, whether to modify the modified allocation data;
in response to determining, based on the one or more second criteria, to modify the modified allocation data, modifying the modified allocation data to indicate a fifth allocation of the resources to the first content delivery channel, wherein the fifth allocation is different than the third allocation.

18. The method of claim 11, wherein:
the resources are first resources that are provided by a first entity;
the method further comprising:
identifying a second plurality of content delivery channels that includes a third content delivery channel;
storing second allocation data that indicates, for each content delivery channel of the second plurality of content delivery channels, an allocation of a portion of second resources to said each content delivery channel, wherein the second resources are provided by a second entity that is different than the first entity;
wherein the second allocation data indicates a fifth allocation of the second resources to the third content delivery channel;
prior to exhaustion of the second resources, determining, based on one or more second criteria, whether to modify the second allocation data;
in response to determining, based on the one or more second criteria, to modify the second allocation data, modifying the second allocation data to indicate a sixth allocation of the second resources to the third content delivery channel, wherein the sixth allocation is different than the fifth allocation.

19. The method of claim 18, wherein the one or more second criteria is different than the one or more criteria.

20. The method of claim 16, wherein the one or more criteria indicates that a certain amount of the first allocation is unconsumed.

21. The method of claim 16, wherein:
the one or more criteria indicates a new content delivery channel that was not allocated any portion of the resources prior to determining whether to modify the allocation data;
the third allocation is less than the first allocation;
modifying the allocation data comprises modifying the allocation data to indicate a fourth allocation of the resources to the new content delivery channel.

22. The method of claim 16, wherein:
the one or more criteria is the first measure of effectiveness being less than a particular threshold measure of effectiveness;
the third allocation is less than the first allocation;
the fourth allocation is greater than the second allocation.

23. The method of claim 22, further comprising:
determining the third allocation and the fourth allocation based on ratio of the first measure of effectiveness to the second measure of effectiveness.

24. The method of claim 11, further comprising, after modifying the allocation data to indicate the third allocation:
prior to exhaustion of the resources, determining whether a particular allocation of the resources to a third content delivery channel of the plurality of content delivery channels is at least approximately equal to a particular minimum threshold;
in response to determining that the particular allocation of the resources to the third content delivery channel is at least approximately equal to the particular minimum threshold, retaining the particular allocation of the resources to the third content delivery channel even though a current measure of effectiveness of the third content delivery channel would cause the particular allocation to decrease if the particular allocation of the resources was substantially greater than the particular minimum threshold.
